(19) United States
(12) Patent Application Publication
(10) Pub. No.: US 2014/0330647 A1
(43) Pub. Date: Nov. 6, 2014

(54) APPLICATION AND SERVICE SELECTION FOR OPTIMIZED PROMOTION

(71) Applicant: INTERNATIONAL BUSINESS MACHINES CORPORATION, Armonk, NY (US)

(72) Inventors: Mihai Christodorescu, Briarcliff Manor, NY (US); Matthew A. Davis, San Jose, CA (US); Sondra R. Renly, Elmsford, NY (US)

(73) Assignee: International Business Machines Corporation, Armonk, NY (US)

(21) Appl. No.: 13/887,185

(22) Filed: May 3, 2013

(51) Int. Cl. G06Q 30/02

(52) U.S. Cl. CPC G06Q 30/0257
USPC 705/14.55

(57) ABSTRACT

Embodiments of the invention relate to application and services promotions. One embodiment includes presenting an application or service by an application or service promotion provider, for exposing, the application or service to potential users. Recommendation and promotion preferences are selected for the application or service. The application or service is provided to an electronic device based on the recommendation and promotion preferences. It is determined whether user action occurs for the application or service using the electronic device. Revenue is generated upon user action occurring for the application or service.

### BACKGROUND

Embodiments of the invention relate to application or service promotion and, in particular, application or service selection for promotions.

There are many mobile applications and cloud services that are undersubscribed because audiences may not know about them or are unwilling to buy an application or service subscription before they can try them. Authors of applications or services can release free versions of their software, but then they lose paying customers. Authors can advertise but this costs seed money and does not overcome a reluctance to buy an unknown product. Authors may rely on user ratings, but again, this involves having buyers first.

### BRIEF SUMMARY

Embodiments of the invention relate to creating exposure for an application or service and revenue generation. One embodiment includes presenting an application or service by an application or service promotion provider, for exposing, the application or service to potential users. Recommendation and promotion preferences are selected for the application or service. The application or service is provided to an electronic device based on the recommendation and promotion preferences. It is determined whether user action occurs for the application or service using the electronic device. Revenue is generated upon user action occurring for the application or service.

These and other features, aspects and advantages of the present invention will become understood with reference to the following description, appended claims and accompanying figures.

### BRIEF DESCRIPTION OF THE SEVERAL VIEWS OF THE DRAWINGS

FIG. 1 depicts a cloud computing node, according to an embodiment of the present invention;

FIG. 2 depicts a cloud computing environment, according to an embodiment of the present invention;

FIG. 3 depicts a set of abstraction model layers, according to an embodiment of the present invention;

FIG. 4 is a block diagram illustrating an example of a server for promotion optimized bid process, according to an embodiment of the present invention;

FIG. 5 is a block diagram illustrating an example of a system for application exposure, according to an embodiment of the present invention;

FIG. 6 is a block diagram illustrating an example of a system for application exposure in a cloud environment, according to an embodiment of the present invention; and

FIG. 7 is a flowchart showing a process for creating revenue streams for applications to electronic devices, in accordance with an embodiment of the invention.

### DETAILED DESCRIPTION

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically, without requiring human interaction with the service's provider.

Broad network access: capabilities are available over a network and accessed through standard mechanisms that promote use by heterogeneously thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

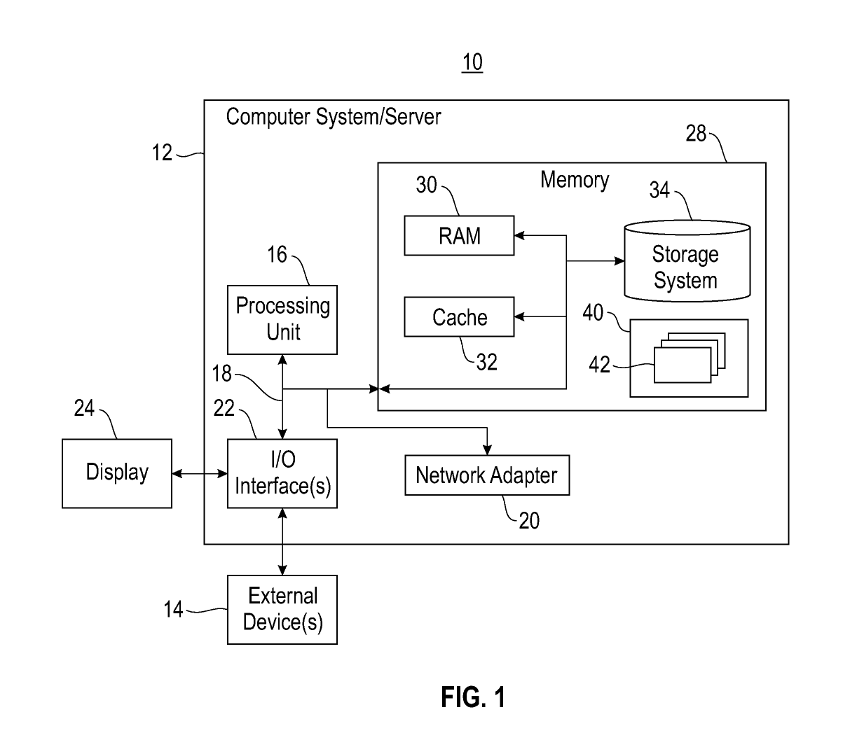

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media and removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, a storage system 34 can be provided for reading from and writing to a non-removable, non-volatile magnetic media (not shown and typically called a “hard drive”. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer-readable signal medium, which may include a propagated data signal with computer-readable program code embodied therein (e.g., in baseband or as part of a carrier wave). Such a propagated signal may take any of a variety of forms including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating systems, one or more application programs, other program modules, and program data or some combination thereof may include an implementation of a networking environment. Program modules 42 generally carry out the functions and/or methodologies of embodiments of the invention as described herein.

Computer system/server 12 may also communicate with one or more external devices 14, such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

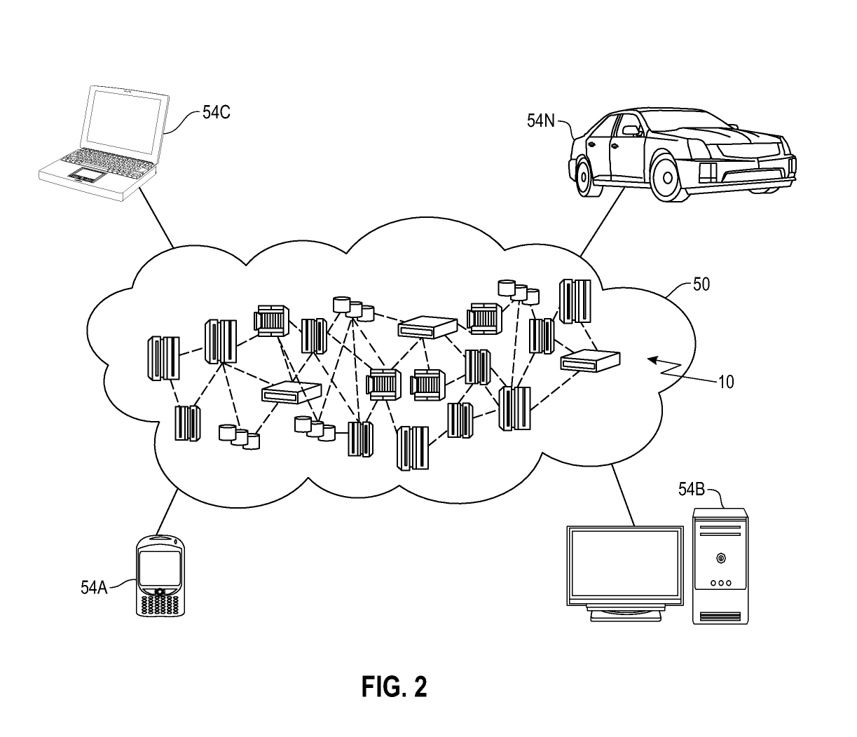

Referring now to FIG. 2, an illustrative cloud computing environment 50 is depicted. As shown, the cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

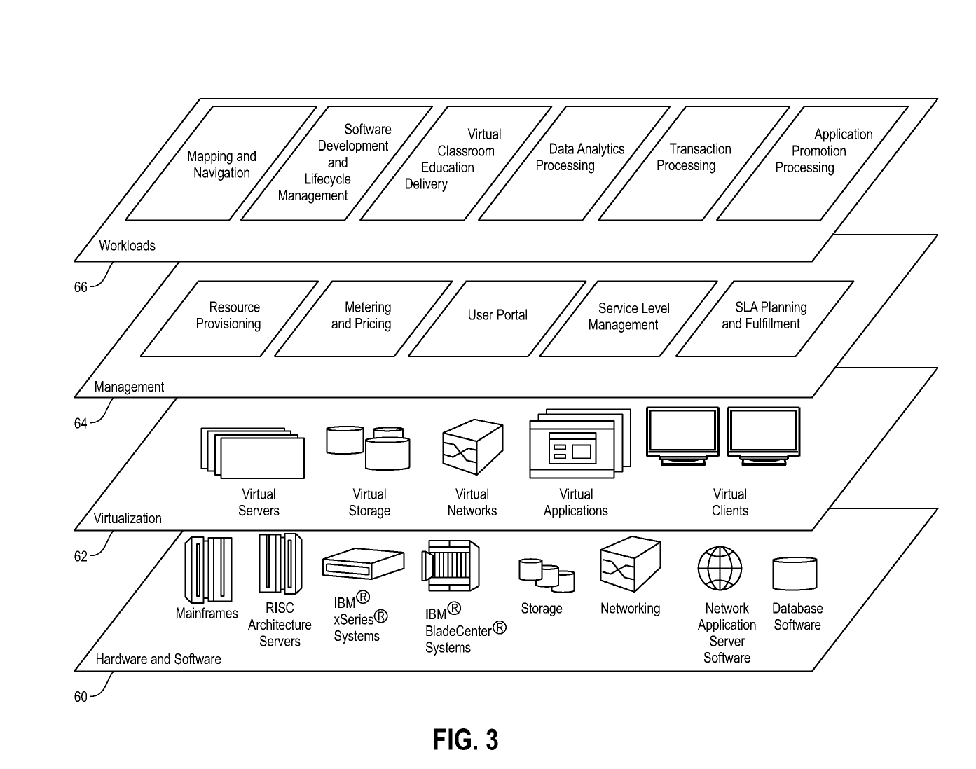

Referring now to FIG. 3, a set of functional abstraction layers provided by the cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, such hardware components comprise IBM® zSeries® systems and RISC (Reduced Instruction Set Computer) architecture-based servers. In one example, such hardware components comprise IBM pSeries® systems, IBM xSeries® systems, IBM BladeCenter® systems, storage devices, networks, and networking components. Examples of software components include network application server software. In one example, such software components comprise IBM WebSphere® application server software and database software. In one example, such software components comprise IBM DB2® database software. (IBM, zSeries, pSeries, xSeries, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment and billing or invoicing for consumption of these resources. In one example, these resources may comprise application software licenses. Security provides identity verification for cloud consumers and tasks as well as protection for data and other resources. Consumer (i.e., user) portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and application promotion processing. As mentioned above, all of the foregoing examples described with respect to FIG. 3 are illustrative only, and the invention is not limited to these examples.

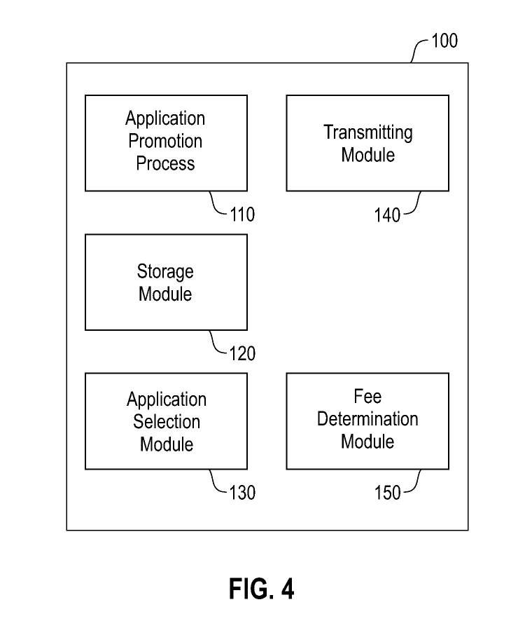

It is understood all functions of the present invention as described herein are typically performed by an application promotion system 100 (FIG. 4), which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of clustered computing environment now known or later developed.

According to an embodiment of the invention, exposure is provided for an application by a service promotion provider. The application or service is provided to an electronic device based on the user promotion preferences and promotion provider algorithms designed to optimize revenue generation. It is determined whether user action occurs for the application or service using the electronic device. Revenue is generated upon user action occurring for the application or service.

FIG. 4 illustrates a block diagram for an application promotion system 100, according to one embodiment of the invention. In one embodiment, the system 100 includes an application promotion process 110, a storage module 120, an application selection module 130, a transmitting module 140 and a fee determination module 150. In one embodiment, the application promotion process determines whether potential participants are eligible to partake in an application promotion, where an application may be an executable application or service (e.g., a cloud service) that is executed or accessed on an electronic device, such as a mobile telephone, a tablet, pad device, personal computer, portable computing device, etc. In one implementation, an owner of an electronic device may opt in or opt out of application promotions by making a selection on the electronic device itself, through an application running on the electronic device, operating system, etc. In another embodiment, a user of an electronic device may opt in based on an application promotion process 110 running on a server, such as a cloud platform environment server. In one or more embodiments, the storage module 120 may comprise of a memory or memory device, and the application selection module 130, the transmitting module 140 and the fee determination module 150 may each comprise a memory unit with computer program instructions. In one embodiment, the application selection module 130 may comprise a first memory unit with computer program instructions for selecting an application or service. In one embodiment, the transmitting module 140 may comprise a second memory unit with computer program instructions for providing the selected application or service to one or more electronic devices. In one embodiment, the fee determination module may comprise a third memory unit with computer program instructions for determining revenue based on user action occurring for selected applications or services.

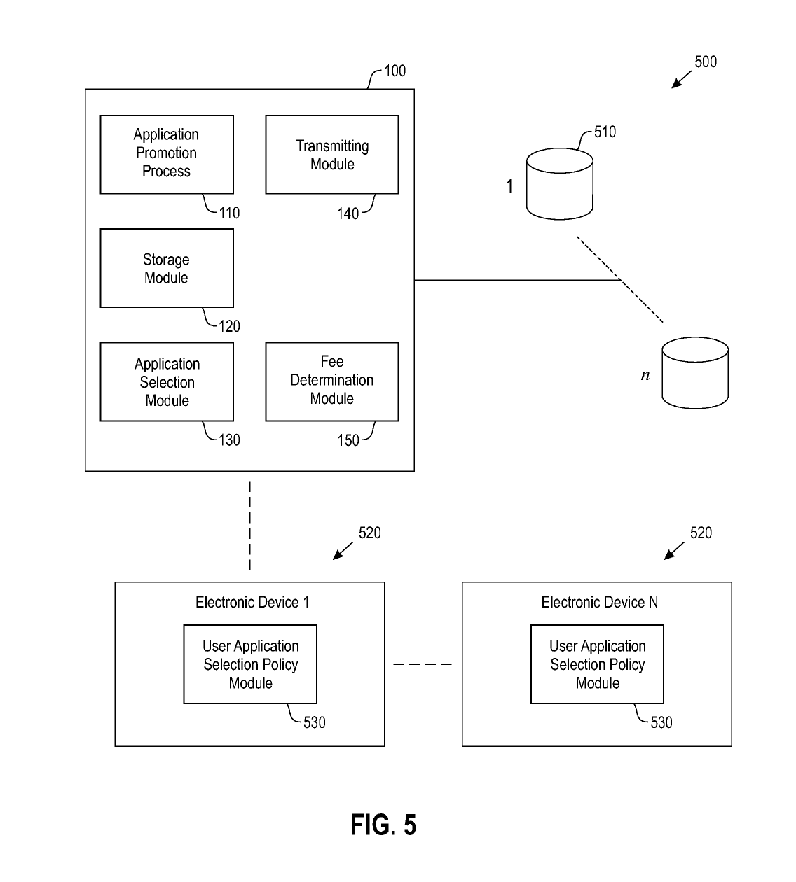

In one implementation, one or more selections for user (of electronic devices) policies for opting in to partake in application promotions may be available for customizing application promotion participation either from system 100 as part of a server (e.g., a cloud server), or a user (of an electronic device) application selection policy module 530 (FIG. 5) on an electronic device (e.g., electronic device 520 in FIG. 5). In one example, the electronic device user's policies for opting in to partake in application promotion may have selections for application category, price, ratings, etc. In other embodiments, the electronic device users may opt in to application promotions based on one or more of demographics, location, subscription history (e.g., news subscription, blog subscriptions, application subscriptions, etc.), one or more social network's subscription history, etc.

In one embodiment, application promotions may be limited by the application selection module 130 to promotional services based on maximum application price, to services with a minimum user base or rankings (e.g., established, bleeding edge, etc.), to services within a particular category, to services provided by a certain type of source organization (e.g., profit, non-profit, etc., where particular types may be blocked), or to services approved by a certain type of member organization (e.g., auto clubs, shopping clubs, etc.).

In one embodiment, electronic device users may adopt a user policy to limit application promotions based on a network connectivity type (such as an open/free network connection (e.g., free and public wireless fidelity (Wi-Fi) connection), paid subscription or paid for based on amount of access (e.g., pay per hour, pay per use based on Mb, etc.), available battery power on an electronic device, processing load on an electronic device, system performance criteria, etc.) by using the application selection module 130 and the transmitting module 140. In one example, only electronic device users having a network connection may receive promotional applications transmitted by the transmitting module 140. In another embodiment, electronic device users may adopt a user policy for opting in to application promotion based on a selected frequency. In one example, electronic device users may select daily, weekly, bi-weekly, monthly, etc. frequencies for opting in to application promotions. In this example, applications may be selected by the application selection module 130 and transmitted based on the opt-in frequency selected by the transmitting module 140.

In one embodiment, electronic device users may opt in or opt out based on allowing/disallowing repeats of application promotions. In one example, an application may be modified, updated, or matured (e.g., bugs removed, improved user interface, etc.). Therefore, an electronic device user may desire to take part in an application promotion for an application that they already participated in to determine whether the application may have improved to their liking.

In one embodiment, an electronic device user may adopt a user policy for selecting whether to save or delete any data created in using a promotional application at the end of the application promotional trial period. If an electronic device user selects to save the data created during an application promotion trial period, the data may be used for a future purchase of the promotional application, which may save time from entering data, creating the data, etc. In one embodiment, the data created during an application trial period may be saved directly on a user device, or on a server, such as a cloud server(s) using the storage module 120.

In one embodiment, an electronic device user may adopt a user policy based on a rating system. In one example, for a rating system on a scale of 1-5 stars, if a ratings selection of a minimum 3 stars is made, the concurrent allowed application promotions may allow all 3+ star-rated applications to have concurrent promotions. Other ratings combinations, minimums, etc. may also be selected as desired.

In one embodiment, service promotion policies from the promotion service provider may dictate participation parameters for the application promotion process 110. In one implementation, promotion service providers may determine the application promotion policies provided by the system 100. In one embodiment, the selection module 130 selects an application to transmit by the transmitting module 140 based on determining whether a client/customer of the promotion service provider has opted in or opted out to allow electronic device users that subscribe to services from the promotion service provider to participate in application promotion programs. In one embodiment, participation in application promotions is based on a desired maximum number (e.g., 1, 5, 10, etc.) of concurrent promotions allowed by a service organization (e.g., company, business, entity, offering or endorsing applications). In one implementation, the maximum number of concurrent allowed application promotions may be based on benchmarks, such as ratings, paid subscriptions, etc. In one example where the opt in to partake in application promotions is based on paid subscriptions, concurrent application promotion may be limited to those having a particular number or set(s) of paid subscriptions (e.g., 3, 4, 5, etc.).

In one embodiment, the fee determination module 150 may determine discounted pricing for application promotion based on a time frame or window, such as discounted pricing for buying now, buying within a week, etc. In another embodiment, the fee determination module 150 may automatically determine discounted pricing based on a pre-established process accounting for current sales. In one implementation, the pre-established process may adjust the price (e.g., dynamically, real-time, etc.) of application promotion services based on the number of sales to date (e.g., the more sold, the lower the price; the more sold, the higher the price, etc.).

In one embodiment, a bid program may be implemented for enabling payment for application promotions that address specific desired targets. In one implementation, the fee determination module 150 may determine to allow bids from current application/service creators that are bidding for promotions to specific type of electronic device users, such as electronic device users that may use specific other services, that are located in a particular market, that belong to a particular demographic, etc. In one embodiment, a revenue generation program may include, but is not limited to, processes, such as the following:
1. Generate revenue by maximizing application promotion bids via one or more bidding programs,
2. Generate revenue from electronic device user actions, such as maximizing users likely to provide ratings, developer feedback comments, social media actions such as feedback “like,” dislike, ratings, recommendations, etc. on subscribed selected social media platforms (e.g., Facebook®, Twitter®, etc.) (these may be limited by what user agrees to share—e.g., demographics, location, rating history),
3. Generate revenue from electronic user actions by maximizing overlapping match pairings:
   Learn which matches are most indicative of a purchase or high user approval rating-publicity (feed to #1, #2), and
4. Generate revenue from electronic user actions by random assignment.

In one embodiment, upon a user purchasing an application from an application promotion offered by a service provider, a fee is collected by the service provider as determined by the fee determination module 150. In one embodiment, the fee is deducted from the collected purchase price. In another embodiment, the fee is collected from authors of applications or services.

In one embodiment, the application selection module 130 selects a “daily” mystery application or service for providing electronic device users exposure to new applications or services that they likely would not have come across on their own and also allows them a period of time (e.g., a day, a week, etc.) to try the application or service for free. In one implementation, there is little effort required for electronic device users to be made aware of new applications or services as a “mystery” application or service is made available (e.g., pushed to an electronic device, alerting an electronic device for pulling, etc.) to users of electronic devices without having to discover the new application or service.

FIG. 5 is a block diagram illustrating an example of a system 500 for application exposure, according to an embodiment of the present invention. In one embodiment, system 500 includes system 100, electronic devices 1-N 520 (where N is a positive integer), and storage devices 1-n 510 (where n is a positive integer). In one embodiment, the electronic devices 1-N 520 include a user application selection policy module 530 for providing the selection policies for application promotion.

In one implementation, system 500 may be a network platform that employs system 100 for application promotion. In one example, the system 100 may be used only on electronic devices 520 (such as a mobile telephone, a tablet, pad device, personal computer, portable computing device, etc.), only on server devices, or on both electronic devices 520 and server devices. In one example, the server devices run the network platform and users use the electronic devices 520 to access the network.

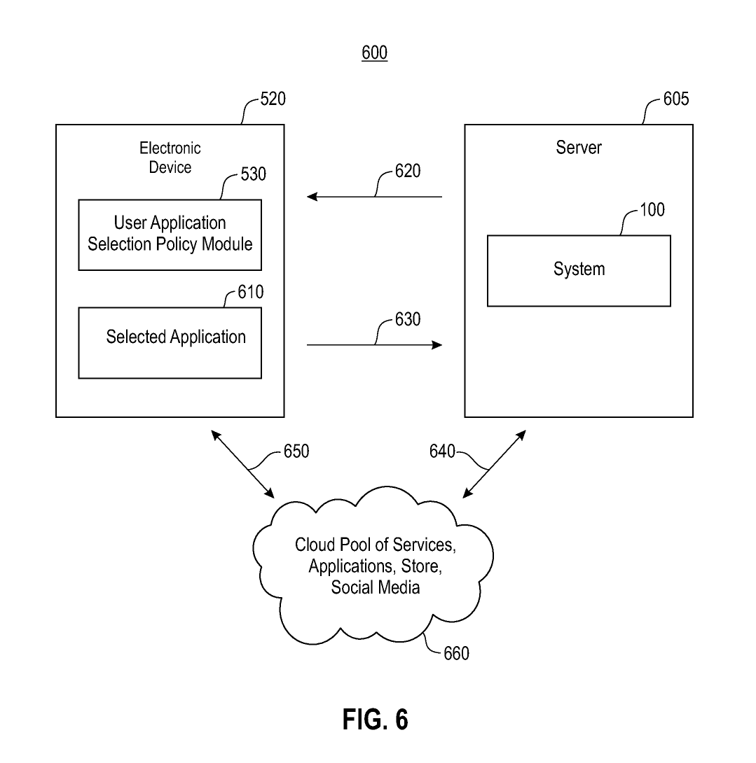

FIG. 6 is a block diagram illustrating an example of a system 600 for application or service exposure in a cloud environment 660, according to an embodiment of the present invention. In one embodiment, the system 600 includes a server 605 including system 100, at least one electronic device 520 including a user application selection policy module 530, and a cloud environment 660. In one embodiment, an application (or service) 610 has been pushed to the electronic device 520 from the cloud platform 660 via communication link 650. In another embodiment, an application (or service) 610 is made available for pulling from the cloud platform 660 to the electronic device 520 via the communication link 650. In one embodiment, communication link 650 may comprise any means for communication, such as wireless, wired, Wi-Fi, Bluetooth, etc. In one embodiment, the server 605 may be part of the cloud environment 660, or communicates with the cloud environment 660 through a link 640, such as wireless, wired, Wi-Fi, Bluetooth, etc.

In one embodiment, the server 605 communicates with the electronic device 520 through links 620 and 630, such as wireless, wired, Wi-Fi, Bluetooth, etc. In one implementation, the links 620 and 630 may be directly connected between the server 605 and the electronic device 520, or indirectly connected through the cloud environment 660. In one embodiment, the cloud environment 660 may comprise access for a pool of cloud services, applications, storage, social media platforms, stores, etc.

In one embodiment, the developer options and service policies are provided from the server 605 for controlling application promotions to the electronic device 520. In one implementation, users may access ratings, recommendations on social media platforms, write feedback, etc. from the electronic device 520 to the cloud environment 660. In one example, based on the user application selection policy provided from the user application selection policy module 530 and the service promotion policy from the system 100, a selected application or service 610 is delivered/provided to the electronic device 610 from the cloud environment 660.

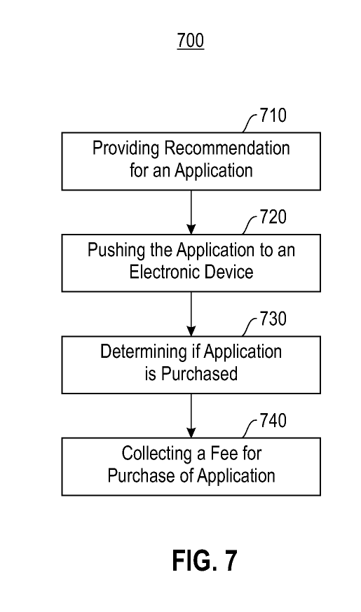

FIG. 7 illustrates a flowchart of an example process 700 for application promotion, according to one embodiment. In process block 710, exposure is provided for an application or service, for example, from an application selection module 130. In process block 720, a selected application or service is provided (e.g., pushed, pulled, etc.) to an electronic device, for example, based on user application selection policy and/or a service promotion policy from system 100. In process block 730, it is determined if user action occurs for an application or service using the electronic device, for example, using electronic device 520 of system 500. In process block 740, a revenue is provided based on the user action occurring for the application or service using the electronic device, for example, to a creator of the application or service, to a promotion provider, etc.

The system 100 and system 500 may include one or more source programs, executable programs (object code), scripts, or any other entity comprising a set of computer program instructions to be performed. When the system 100 or system 500 includes a source program, then the program is usually translated via a compiler, assembler, interpreter, or the like, which may or may not be included within a storage device. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a non-exhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

In one embodiment, where the system 100 or system 500 is implemented in hardware, the system 100 or system 500 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be emphasized that the above-described embodiments of the present invention, particularly, any “preferred” embodiments, are merely possible examples of implementations, merely set forth for a clear understanding of the principles of the invention.

Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method comprising:
presenting an application or service by an application or service promotion provider, for exposing, the application or service to potential users;
selecting recommendation and promotion preferences for the application or service;
providing the application or service to an electronic device based on the recommendation and promotion preferences;
determining whether user action for the application or service occurs using the electronic device; and
generating revenue upon user action occurring for the application or service.

2. The method of claim 1, further comprising:
selecting promotion preferences on an electronic device; and
determining a user application and service selection policy based on the selected promotion preferences and the promotion provider algorithms designed to optimize revenue generation.

3. The method of claim 2, further comprising:
selecting the application or service from a plurality of applications or a plurality of services based on developer criteria; and
providing the selected application or service to the electronic device based on the user application and service selection policy.

4. The method of claim 3, further comprising:
determining a developer policy based on:
a maximum number of applications or services to provide to electronic devices; and
application or service price range.

5. The method of claim 1, wherein providing the promotion comprises:
providing a combination of multiple promotions for the application or service from multiple social media platforms; and
limiting promotions provided to the electronic device based on the user application and service selection policy.

6. The method of claim 2, wherein selecting promotion preferences on the electronic device comprises selecting one or more types of personal information for sharing with the application or service provider.

7. The method of claim 6, wherein the personal information comprises:
one or more of: demographics, location, subscription history, purchase history, promotion opt-in status, and social media platform subscription history.

8. The method of claim 7, wherein said exposing is further based on a service or application promotion policy based on one or more of: user opt-in status, maximum allowed concurrent promotions, adjusted application or service price based on promotion time frame, and bid program criteria for enabling revenue generation for promotions.

9. The method of claim 8, wherein the bid program criteria is based on one or more of: whether users are current users of particular services, user location, and user demographics.

10. The method of claim 8, wherein user opt-in status is based on one or more of: maximum application or service price, applications or services with a minimum user base, minimum ranking, applications or services based on a particular category, applications or services provided by particular type of organization, applications or services approved by particular organizations, promotions limited to type of network connectivity, and selected frequency of promotion participation.

11. A computer program product for providing applications or services to electronic devices, the computer program product comprising a computer readable storage medium having program code embodied therewith, the program code executable by a processor to:
present, by the processor, a promotion for an application or service by an application or service provider, for exposing, the application or service to potential users;
select, by the processor, recommendation and promotion preferences for the application or service;
provide, by the processor, the application or service to an electronic device based on the recommendation and promotion preferences, and promotion provider algorithms designed to optimize revenue generation;
determine, by the processor, whether user action for the application or service occurs using the electronic device; and
generate revenue upon determining user action occurred for the application or service.

12. The computer program product of claim 11, the program code executable by the processor further to:
determine, by the processor, selected promotion preferences on an electronic device;
determine, by the processor, a user application and service selection policy based on the selected promotion preferences and promotion provider algorithms designed to optimize revenue generation;
select, by the processor, the application or service from a plurality of applications or a plurality of services based on developer criteria; and
provide, by the processor, the selected application or service to the electronic device based on the user application and service selection policy.

13. The computer program product of claim 12, further comprising program code executable by the processor to:
determine, by the processor, a developer policy based on: a maximum number of applications or services to provide to electronic devices,
wherein exposing the application or service to potential users comprises program code executable by the processor to:
provide, by the processor, a combination of multiple promotions for the application or service from multiple social media platforms; and
limit, by the processor, exposure provided to the electronic device based on the user application and service selection policy.

14. The computer program product of claim 13, wherein selection of promotion preferences comprises selecting one or more types of personal information for sharing with the application or service provider, and wherein the personal information comprises: one or more of: demographics, location, subscription history, purchase history, promotion opt-in status, and social media platform subscription history.

15. The computer program product of claim 13,
wherein a promotion is based on a service or application promotion policy based on one or more of: user opt-in status, maximum allowed concurrent promotions, adjusted application or service price based on promotion time frame, and bid program criteria for enabling revenue generation for promotions,
wherein the bid program criteria is based on one or more of: whether users are current users of particular services, user location and user demographics, and
wherein user opt-in status is based on one or more of: maximum application or service price, applications or services with a minimum user base, minimum ranking, applications or services based on a particular category, applications or services provided by particular type of organization, applications or services approved by particular organizations, promotions limited to type of network connectivity, and selected frequency of participation.

16. A system comprising:
a server including an application and service promotion process;
a memory for storing a plurality of applications;
a first memory unit with computer program instructions for selecting an application or service;
a second memory unit with computer program instructions for providing the selected application or service to one or more electronic devices; and
a third memory unit with computer program instructions for determining revenue based on user action occurring for selected applications or services.

17. The system of claim 16, wherein the application and service promotion process determines selected promotion preferences on the electronic device, and determines a user application and service selection policy based on the selected promotion preferences.

18. The system of claim 17, wherein the server presents the selected application or service for exposing the selected application or service to potential users using the application and service promotion policy based on obtaining a combination of multiple recommendations for the application or service from multiple social media platforms.

19. The system of claim 18, wherein exposing the selected application or service to potential users is further based on one or more of: user opt-in status, maximum allowed concurrent promotions, adjusted application or service price based on promotion time frame, and bid program criteria for enabling revenue generation for promotions,
wherein the bid program criteria is based on one or more of: whether users are current users of particular applications or services, user location and user demographics, and
wherein user opt-in status is based on one or more of: maximum application or service price, applications or services with a minimum user base, minimum ranking, applications or services based on a particular category, applications or services provided by particular type of organization, applications or services approved by particular organizations, promotions limited to type of network connectivity, and selected frequency of participation.

20. The system of claim 19, wherein an application or service provider receives revenue for user action occurring for an application or service during a promotional period.
